(19) United States
(12) Patent Application Publication
(10) Pub. No.: US 2025/0203731 A1
(43) Pub. Date: Jun. 19, 2025

(54) MITIGATION OF LIGHT EMITTING DIODE (LED) DISPLAY DRIVER INPUT PEAK POWER IN AUGMENTED REALITY (AR) / VIRTUAL REALITY (VR) DEVICES

(71) Applicant: Meta Platforms Technologies, LLC., Menlo Park, CA (US)

(72) Inventors: Baifeng CHEN, San Jose, CA (US); Yewching CHEN, Cupertico, CA (US); Suhas GUPTA, San Jose, CA (US); Xiang ZHANG, Newark, CA (US); ALI TATARI, Tracy, CA (US); Zhaonian ZHANG, Sunnyvale, CA (US); Xiaofei MA, San Ramon, CA (US); Omar ZAKARIA, Saratoga, CA (US); Yuhao WANG, Palo Alto, CA (US); Aditya GADRE, Vancouver (CA); Gregory GIBSON, Duvall, WA (US)

(73) Assignee: Meta Platforms Technologies, LLC., Menlo Park, CA (US)

(21) Appl. No.: 18/545,497

(22) Filed: Dec. 19, 2023

Related U.S. Application Data
(60) Provisional application No. 63/451,259, filed on Mar. 10, 2023.

(51) Int. Cl. H05B 45/375; G09G 3/32; H05B 45/38; H05B 47/16

(52) U.S. Cl. CPC H05B 45/375; G09G 3/32; H05B 45/38; H05B 47/16; G09G 2300/0452; G09G 2360/00

(57) ABSTRACT

A power management system for a display light emitting diode (LED) driver for an augmented reality/virtual reality (AR/VR) device mitigates (e.g., attenuates) an input peak power delivered to the LED driver from a DC source and decreases a voltage ramp rate of the LED driver while maintaining the default current ramp rate or vice versa. A liquid crystal on silicon (LCOS) digital process is used to provide a current reference with a slow ramp rate and/or to provide an offset. The offset (e.g., a delay) may be implemented between the voltage ramp and the current ramp to achieve a non-overlapping output voltage and output current.

### CROSS REFERENCE TO RELATED APPLICATIONS

This patent application claims priority to U.S. Provisional Patent Application No. 63/451,259, entitled “MITIGATION OF LIGHT EMITTING DIODE (LED) DISPLAY DRIVER INPUT PEAK POWER IN AUGMENTED REALITY (AR)/VIRTUAL REALITY (VR) DEVICES,” filed on Mar. 10, 2023.

### TECHNICAL FIELD

This patent application relates generally to augmented reality (AR)/virtual reality (VR) display systems, and more specifically, to mitigation of light emitting diode (LED) display driver input peak power in augmented reality (AR)/virtual reality (VR) devices.

### BACKGROUND

With recent advances in technology, OLED based display systems, where an emissive electroluminescent layer is a film of organic compound that emits light in response to an electric current, have become common in devices such as television screens, computer monitors, and portable systems such as smartphones, VR devices, handheld game consoles, and smart watches. The organic layer is placed between two electrodes, at least one of which is transparent.

To enhance user experience augmented reality (AR)/virtual reality (VR) display devices are equipped with high performance displays or projectors. Such devices may include light emitting diode (LED) source and driver circuitry. As available power (e.g., battery power) for augmented reality (AR)/virtual reality (VR) display devices is limited, peak power requirements of light emitting diode (LED) source and driver circuitry may present a challenge.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1A illustrates a block diagram of a computing device with a display, according to an example.

FIG. 1B illustrates a block diagram of a light emitting diode (LED) based display, according to an example.

FIG. 2A illustrates a light emitting diode (LED) drive control system diagram for a pixel of a display, according to examples.

FIG. 2B illustrates input/output currents and voltages and a peak input power of a light emitting diode (LED) driver circuit, according to examples.

FIG. 2C illustrates ramp-up voltage and current values and representations and measurements of peak power from voltage and current transients in a light emitting diode (LED) driver circuit, according to examples.

FIG. 3 illustrates representations of ramp-up voltage and current values and peak power from voltage and current transients in various light emitting diode (LED) driver circuits, according to examples.

FIGS. 4A through 4E illustrate measurements of input/output voltages, currents, and powers in various light emitting diode (LED) driver circuits, according to examples.

FIG. 5A illustrates representations of ramp-up voltage and current values and peak power from voltage and current transients, and measurements of peak power in various light emitting diode (LED) driver circuits, according to examples.

FIG. 5B illustrates a comparison of input instant powers from voltage and current transients in various light emitting diode (LED) driver circuits, according to examples.

FIG. 5C illustrates a comparison of input peak powers from voltage and current transients in various light emitting diode (LED) driver circuits, according to examples.

FIG. 6 illustrates a schematic diagram of a light emitting diode (LED) drive control system for a pixel of a display and mitigation of peak input power processes, according to examples.

FIG. 7A illustrates light emitting diode (LED) voltage and current graphs for a complementary voltage-current ramping technique, according to examples.

FIG. 7B illustrates light emitting diode (LED) voltage, current, and power measurement for a complementary voltage-current ramping technique, according to examples.

FIG. 8 illustrates a flow diagram for a method of mitigating peak input power for a light emitting diode (LED) driver circuit, according to examples.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

As used herein, a “near-eye display” may refer to any display device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein, a “user” may refer to a user or wearer of a “near-eye display.” As used herein, a “wearable device” may refer to any portable electronic device that may be worn on any body part of a user and used to present audio and/or video content, control other devices, monitor bodily functions, and perform similar actions.

Some wearable devices, such as virtual reality (VR), augmented reality (AR), and/or mixed reality (MR) glasses may be equipped with high performance displays or projectors. Such displays or projectors may include light emitting diode (LED) source and driver circuitry. Furthermore, augmented reality (AR)/virtual reality (VR) display devices may be powered by an embedded battery, peak power requirements of light emitting diode (LED) source and driver circuitry may exceed battery capacity causing brownouts. Moreover, due to high source impedance of common light emitting diode (LED) source and driver circuitry battery time may be reduced.

In some examples of the present disclosure, a power management system for an augmented reality (AR)/virtual reality (VR) display may reduce peak input power for light emitting diode (LED) driver circuitry. The power management system may mitigate (e.g., attenuates) an input peak power delivered to the light emitting diode (LED) driver circuitry from a direct current (DC) source such as a battery through a number of techniques. In one implementation, input voltage ramp up speed may be controlled (decreased) while maintaining a current ramp up speed at the default rate. In another implementation, input current ramp up speed may be controlled (decreased) while maintaining a voltage ramp up speed at the default rate. In a further implementation, non-overlapping voltage and current ramp up profiles may be used. In yet another implementation, input voltage may be ramped down while input current is ramped up in a complementary manner. All implementations may result in reduction of input peak power increasing battery life and preventing brownouts. Some of the techniques may be accomplished through light emitting diode (LED) driver silicon process, while other techniques may be accomplished by a liquid crystal on silicon (LCOS) digital process or a combination thereof.

In some examples, battery life of augmented reality (AR)/virtual reality (VR) display devices may be increased and/or brownouts due to high input peak power requirements of light emitting diode (LED) driver circuitry may be avoided through various mitigation techniques described herein. Other benefits and advantages may also be apparent.

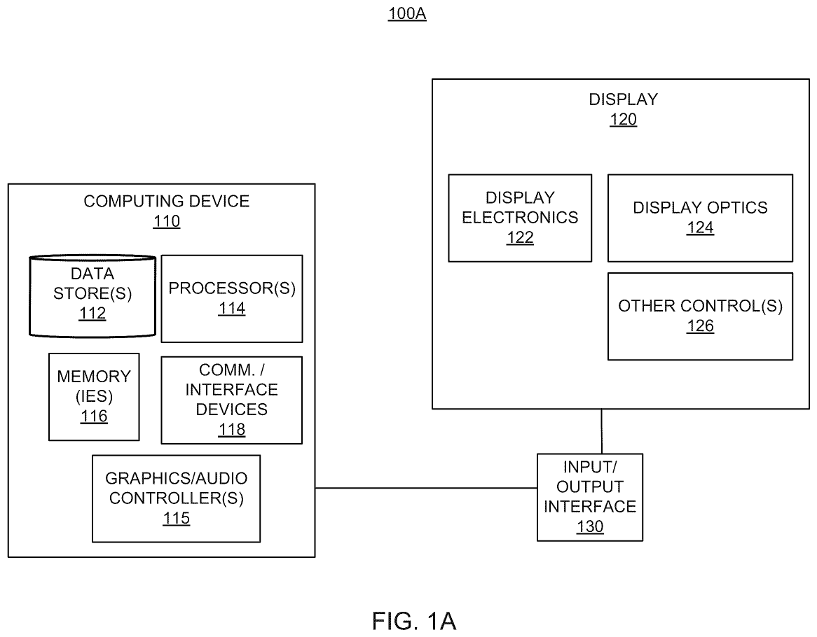

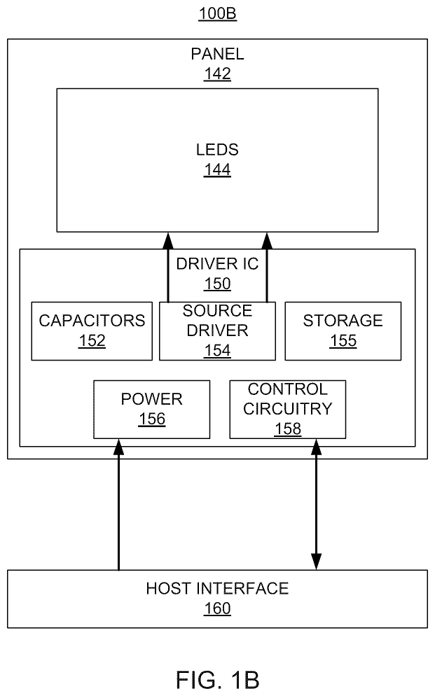

FIG. 1A illustrates a block diagram of a computing device with a display, according to an example. The diagram 100A shows a system environment that includes a computing device 110 with a display 120. The display 120 may be a near-eye display device (an implementation of a wearable device), specifically, a head-mounted display (HMD) device configured to operate as a virtual reality (VR) display, an augmented reality (AR) display, and/or a mixed reality (MR) display.

As used herein, a “display” may refer to a device that presents content (e.g., video, still images, three-dimensional images, etc.). As used herein, “an LED display” may refer to display devices that use light emitting diode (LED) technology and may be implemented in various shapes and forms. Such light emitting diode (LED) displays may include use of technologies associated with virtual reality (VR), augmented reality (AR), and/or mixed reality (MR). As used herein a “user” may refer to a user observing a display or wearer of a “wearable LED display.”

As shown in diagram 100A, the system environment may also include an input/output interface 130 coupled between the computing device 110 and the display 120 to enable communication and data exchange between the two. The computing device 110 may include a number of components and sub-systems such as data storage(s) 112, processor(s) 114, memory(ies) 116, communication/interface devices 118, and graphics/audio controller(s) 115, among others. The display 120 may include display electronics 122, display optics 124, and other control(s) 126, among other things. In some examples, part or all of the computing device 110 may be integrated with the display 120.

In some instances, the computing device 110 may be any device capable of providing content to the displayed to the display 120 including, but not limited to, a desktop computer, a laptop computer, a portable computer, a wearable computer, a smart television, a server, a game console, a communication device, a monitoring device, or comparable devices. The computing device 110 may execute one or more applications, some of which may be associated with providing content to be displayed to the display 120. The applications (and other software) may be stored in data storage(s) 112 and/or memory(ies) 116 and executed by processor(s) 114. Communication/interface devices 118 may be used to receive input from other devices and/or human beings, and to provide output (e.g., instructions, data) to other devices such as the display 120. Graphics/audio controller(s) 115 may be used to process visual and audio data to be provided to output devices. For example, video or still images may be processed and provided to the display 120 through the graphics/audio controller(s) 115.

In some examples, the data store(s) 112 (and/or the memory(ies) 116) may include a non-transitory computer-readable storage medium storing instructions executable by the processor(s) 114. The processor(s) 114 may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the computing device 110 described in conjunction with FIG. 1A may be encoded as instructions in the non-transitory computer-readable storage medium that, when executed by the processor, may cause the processor to perform the functions further described below.

In some examples, the data storage(s) 112 may store one or more applications for execution by the computing device 110. An application may include a group of instructions that, when executed by a processor, generates content for presentation to the user. Examples of the applications may include gaming applications, conferencing applications, video playback application, or other suitable applications.

In some examples, the display 120 may be used to display content provided by the computing device 110 and may take many different shapes or forms. For example, the display 120 may be a desktop monitor, a wall-mount monitor, a portable monitor, a wearable monitor (e.g., VR or AR glasses), and comparable ones to name a few. The display 120 may include display electronics 122, display optics 124, and other control(s) 126.

In some examples, the display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

In some examples, the display 120 may be implemented in any suitable form-factor as mentioned above, including a head-mounted display, a pair of glasses, or other similar wearable eyewear or device. Examples of the display 120 are further described below with respect to FIG. 1B. Additionally, in some examples, the functionality described herein may be used in a head-mounted display or headset that may combine images of an environment external to the display 120 and artificial reality content (e.g., computer-generated images). Therefore, in some examples, the display 120 may augment images of a physical, real-world environment external to the display 120 with generated and/or overlaid digital content (e.g., images, video, sound, etc.) to present an augmented reality to a user.

In some examples, the display electronics 122 may display or facilitate the display of images to the user according to data received from, for example, the computing device 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the display electronics 122 may include circuitry to provide power to the pixels, control behavior of the pixels, etc. Control circuitry, also referred to as “drivers” or “driving circuitry”, may control which pixels are activated, a desired gray level for each pixel in some examples.

In some examples, the display optics 124 may display image content optically (e.g., using optical waveguides and/or couplers) or magnify image light received from the display electronics 122, correct optical errors associated with the image light, and/or present the corrected image light to a user of the display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display 120 may include additional modules and/or functionality such as audio output, image capture, location/position sensing. Other control(s) 126 may be employed to control such functionality (e.g., level and/or quality of audio output, image capture, location/position sensing, etc.), as well as functionality of the display 120 such as wireless remote control of the display 120.

In some examples, the display 120 may be an organic light emitting diode (OLED), liquid crystal on silicon (LCOS), or microLED type display. An organic light emitting diode (OLED) display may include a layer of organic materials situated between two electrodes, all deposited on a substrate. Varying conductivity levels of the organic molecules may be taken advantage of by applying different voltages to the electrodes and emitting light to project images. Thus, the display electronics 122 may include driving circuitry for each of the pixels.

Based on their emission types, physical structures, etc., organic light emitting diode (OLED) displays may be divided into different types. Transparent organic light emitting diode (OLED) displays have only transparent components (substrate, cathode and anode) and, when turned off, are up to 85 percent as transparent as their substrate. When a transparent organic light emitting diode (OLED) display is turned on, it allows light to pass in both directions. White organic light emitting diode (OLED) displays emit white light that is brighter, more uniform and more energy efficient than that emitted by fluorescent lights. White organic light emitting diode displays (OLEDs) also have the true-color qualities of incandescent lighting. Bottom-emission OLED (BE-OLED) has a transparent anode fabricated on a glass substrate, and a shiny reflective cathode. Light is emitted from the transparent anode direction. Top-emission OLED (TE-OLED) has a substrate that is either opaque or reflective and is more suited to active-matrix design.

In some examples, the computing device 110 may provide content to the display 120 for presentation to the user through the input/output interface 130. The input/output interface 130 may facilitate data exchange between the computing device 110 and the display 120 through wired or wireless means (e.g., through radio frequency waves or optical waves) and include circuitry/devices to process exchanged data. For example, the input/output interface 130 may condition, transform, amplify, or filter signals exchanged between the computing device 110 and the display 120. The computing device 110 and/or the display 120 may include different or additional modules than those described in conjunction with FIG. 1A. Functions further described herein may be distributed among components of the computing device 110 and the display 120 in a different manner than is described here.

FIG. 1B illustrates a block diagram of a light emitting diode (LED) based display, according to an example. In some examples, the display in diagram 100B may be a specific implementation of display 120 of FIG. 1A and may be configured to operate as a VR display, an AR display, and/or a MR display.

In some examples, the display may include a panel 142 containing light emitting diodes (LEDs) 144 and driver IC 150. In some examples, the display may be configured to present media or other content to a user through controlled activation and emission of the light emitting diodes (LEDs) 144. In some examples, the driver IC 150 may include electronics to perform functionality similar to those described with respect to FIG. 1A. The driver IC 150 may include, for example, source driver 154, capacitors 152, storage 155, power circuitry 156, and control circuitry 158. The panel 142 may be communicatively coupled (wired or wireless) to host interface 160. In some examples, the display may also include any number of optical components, such as waveguides, gratings, lenses, mirrors, etc. The source driver 154 may include an activation circuit and a converter circuit for each LED or groups of LEDs in the display.

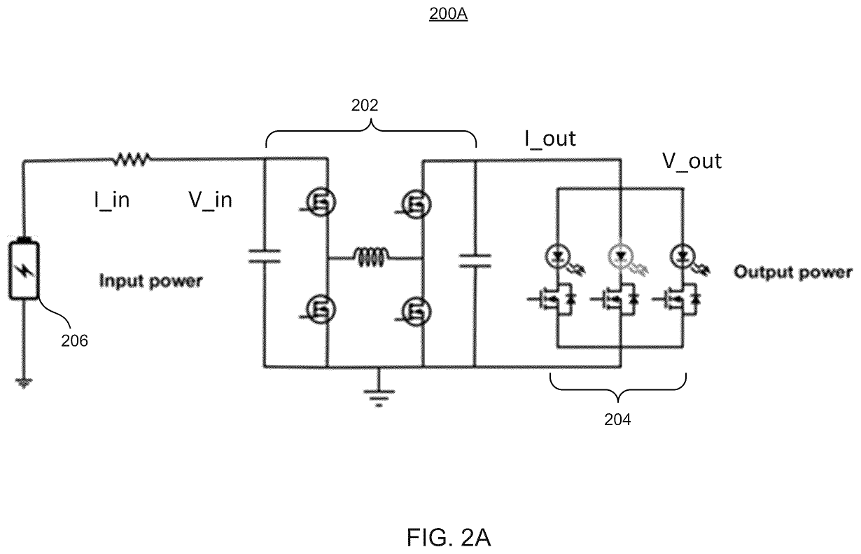

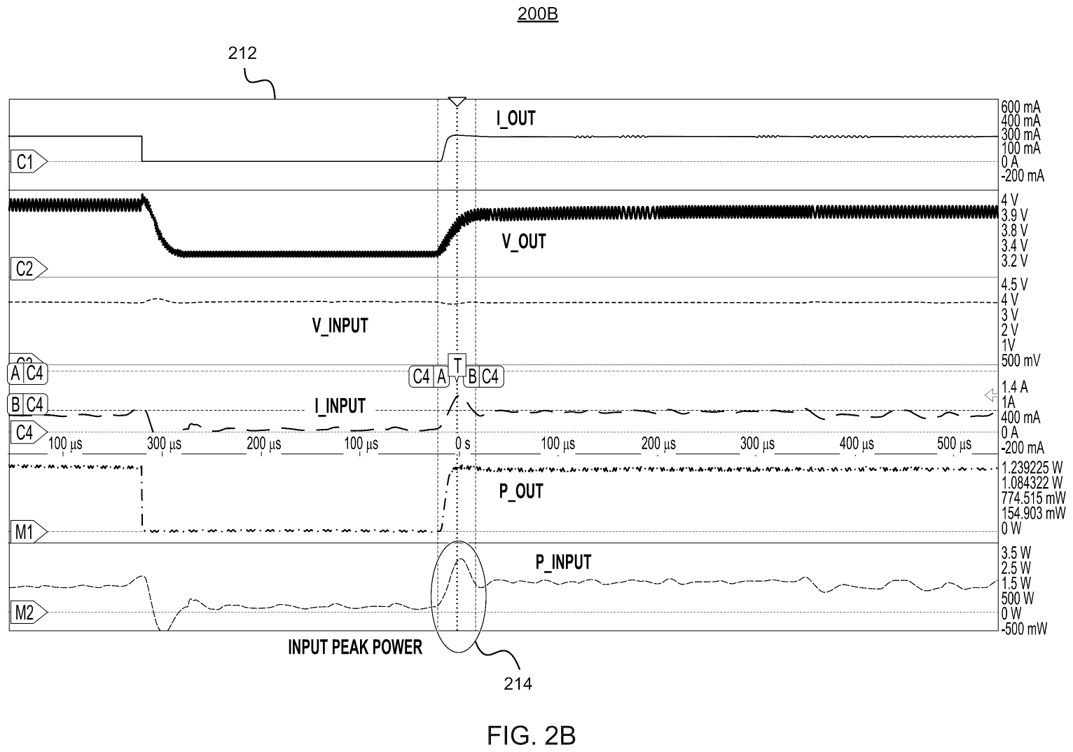

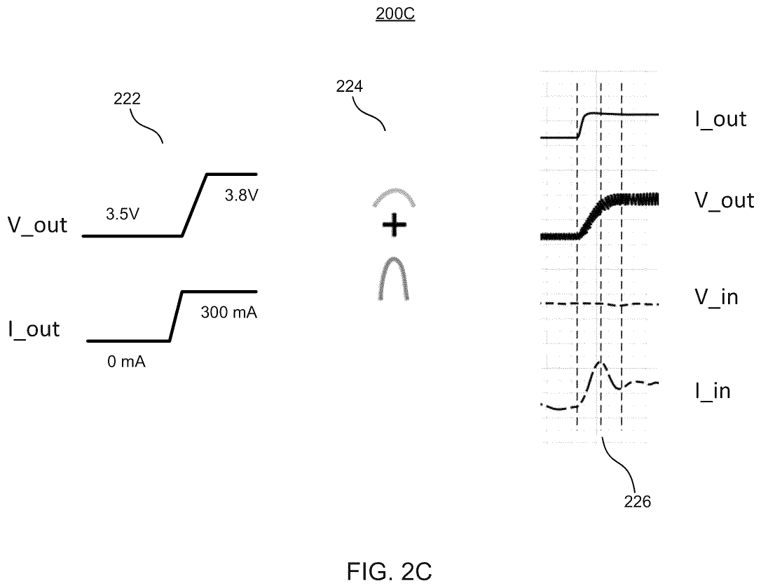

While the components of driver IC 150 and/or other components may be employed for displays such as organic light emitting diode (OLED) displays, relatively simpler light emitting diode (LED) displays may employ less complex driver circuitry as discussed in conjunction with FIG. 2A. In some examples, the driver IC 150 may be a liquid crystal on silicon (LCOS) application specific integrated circuit (ASIC).

FIG. 2A illustrates a light emitting diode (LED) drive control system circuit diagram for a pixel of a display, according to examples. Diagram 200A shows the drive control system coupled to a DC power source 206 (e.g., a battery) with an input current and input voltage being boosted by a DC-to-DC converter 202 and driving red, green, and blue light emitting diodes (LEDs) 204 with an output current and an output voltage. An output power of the circuit is a product of the output voltage and the output current.

In an operation, when a light emitting diode (LED) is activated, the input voltage and the input current are ramped up, which causes a peak in the power level before the voltage and the current (and thereby the power) are stabilized. While the battery may be designed to provide a stable source of power during the light emitting diode's (LED's) operation, the initial peak in the power may drain the battery potentially causing a brownout and/or reducing the battery's life.

Diagram 200B in FIG. 2B illustrates input/output currents and voltages and a peak input power of a light emitting diode (LED) driver circuit, according to examples. Measurement screenshot 212 in FIG. 2B shows the ramping up of the output voltage and the output current, along with the output power, and the resulting peak 214 in the input power.

FIG. 2C illustrates ramp-up voltage and current values and representations and measurements of peak power from voltage and current transients in a light emitting diode (LED) driver circuit, according to examples. Diagram 200C shows output voltage and output current ramp up profiles 222, where the output voltage rises from 3.5 V to 3.8 V and the output current rises from 0 mA to 300 mA, for example. Peak power representations 224 from corresponding voltage and current transients are also shown in the diagram. Diagram 200C further includes a measurement screenshot 226 showing how the peak power components from corresponding voltage and current transients are added because the voltage and current transients largely overlap.

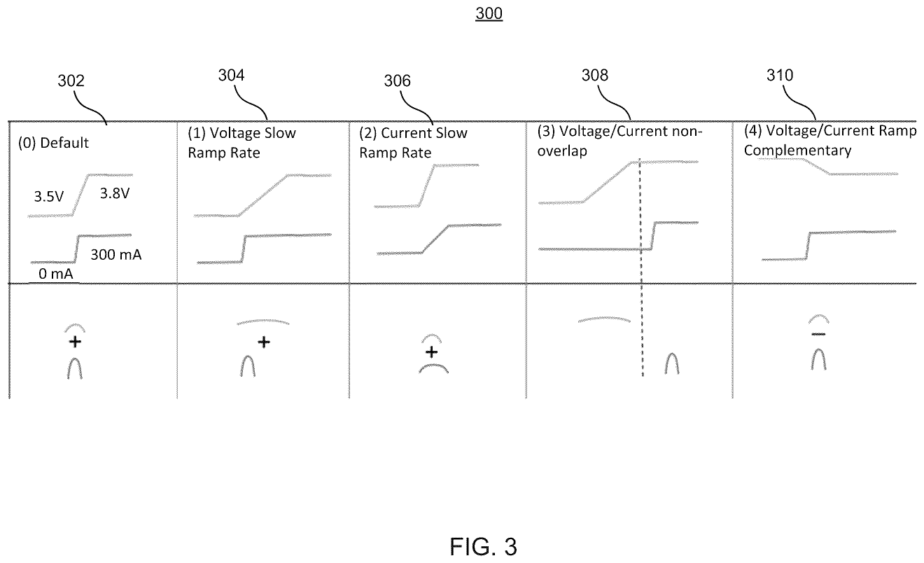

FIG. 3 illustrates representations of ramp-up voltage and current values and peak power from voltage and current transients in various light emitting diode (LED) driver circuits, according to examples. Diagram 300 shows a comparison of unmitigated and four different mitigated ramp up scenarios of peak input power in a light emitting diode (LED) driver circuit.

A first example ramp up scenario 302 is the same as in FIG. 2C, where the power peaks from transient voltage and current overlap and maximize the peak input power. A second example scenario 304 shows the voltage ramp up rate being slowed while the current ramp up rate is maintained resulting in a smaller peak component of the input power from the voltage transient, thus an overall smaller peak input power. A third example scenario 306 shows the current ramp up rate being slowed while the voltage ramp up rate is maintained resulting in a smaller peak component of the input power from the current transient, thus an overall smaller peak input power.

A fourth example scenario 308 in diagram 300 shows a time offset being introduced between the voltage ramp up and the current ramp up. Thus, the voltage and current transients no longer overlap resulting in an even smaller overall peak input power. The peak power reduction result of the fourth example scenario 308 may be achieved by offsetting either the voltage ramp up or the current ramp up. A fifth example scenario 310 shows the voltage ramp up profile being reversed, where the voltage ramps down from a blanking voltage value instead of ramping up while the current ramp up profile is maintained. Thus, the voltage and current ramp profiles become complementary achieving highest reduction in peak input power among the displayed mitigation scenarios.

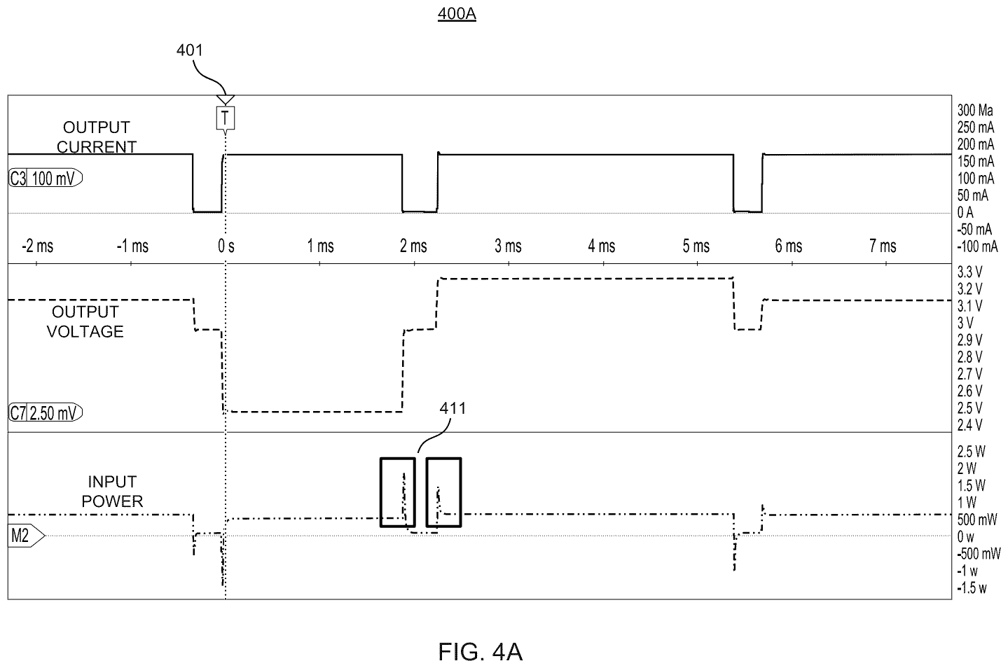

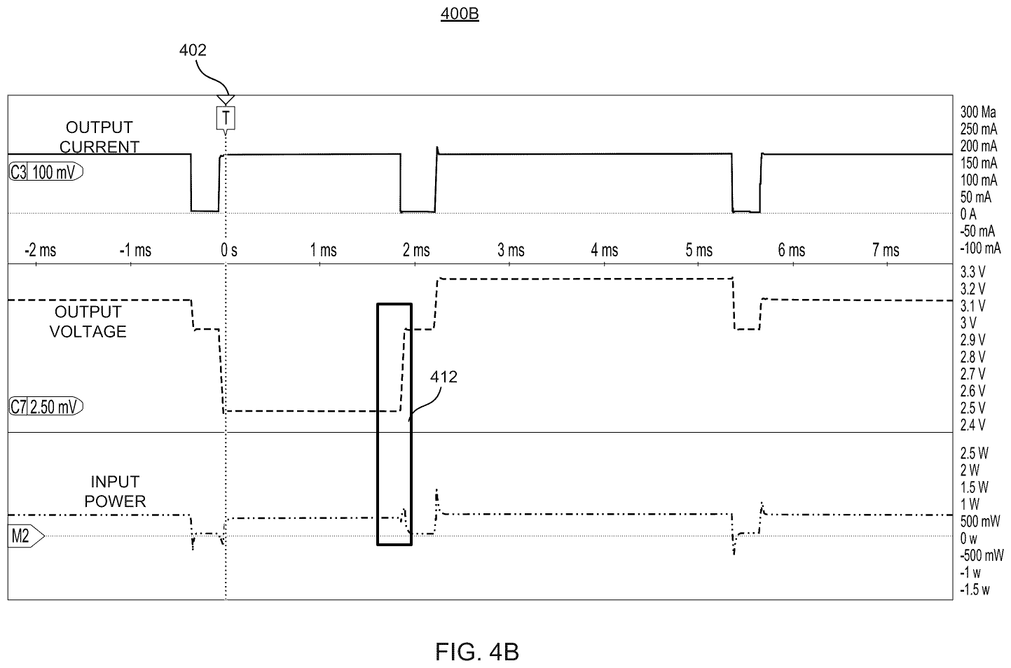

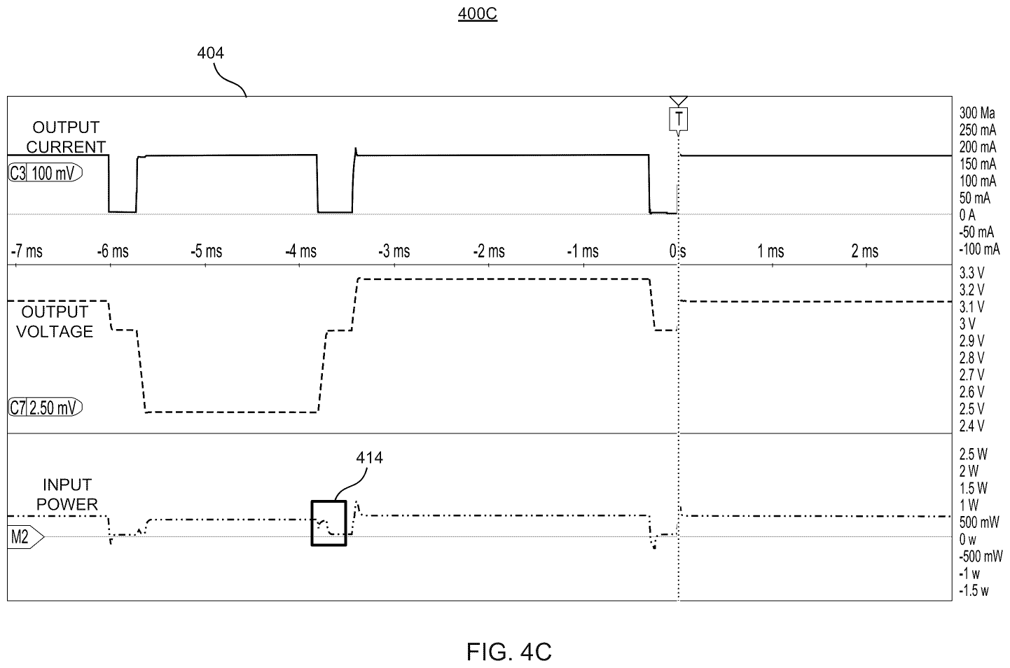

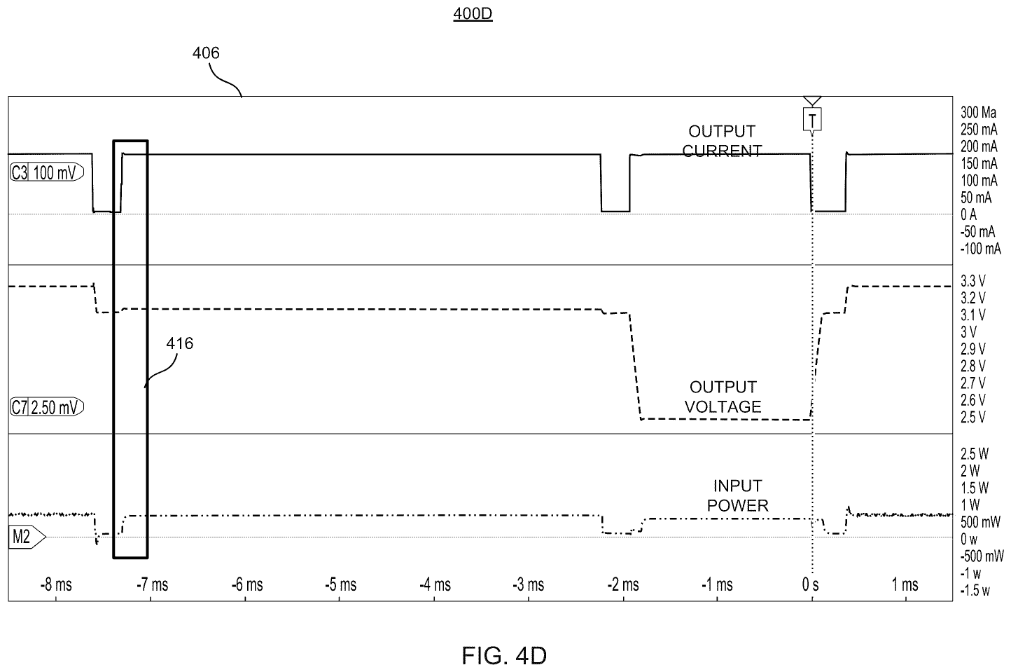

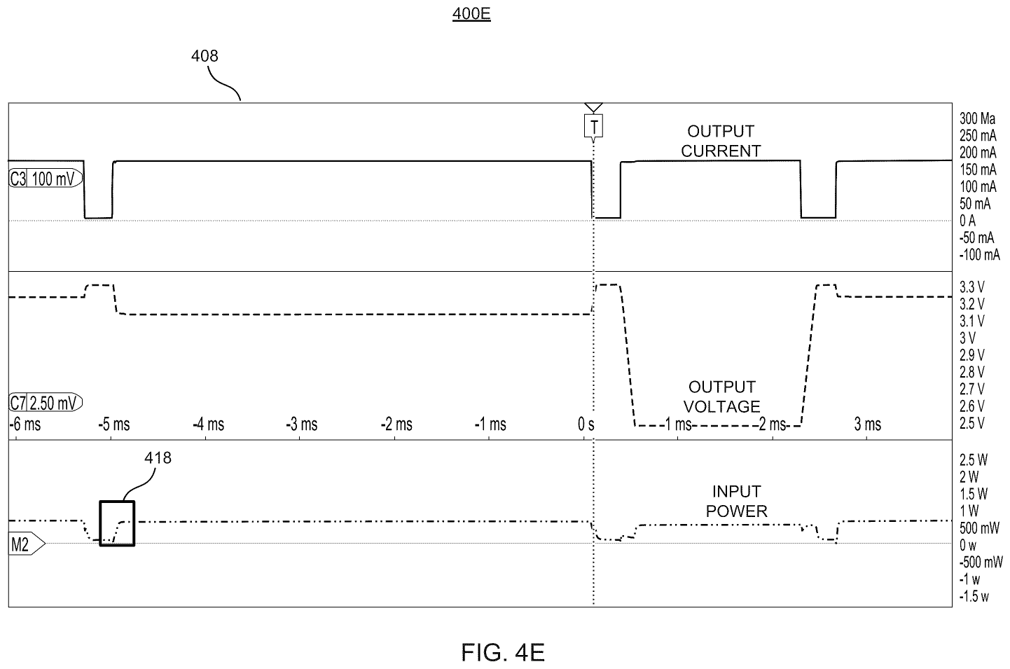

FIGS. 4A through 4E illustrate measurements of input/output voltages, currents, and powers in various light emitting diode (LED) driver circuits, according to examples. Diagram 400A in FIG. 4A shows a measurement screenshot 401 for the first example scenario without mitigation. The measurement screenshot 402 shows output voltage and current waveforms along with input power. The input power waveform includes the peak input power 411 when the LED voltage and current are transient (and overlapping) as described herein.

Diagram 400B in FIG. 4B shows a measurement screenshot 402 for the second example scenario, where the voltage ramp up rate is slowed while the current ramp up rate is maintained resulting in a smaller peak component 412 of the input power from the voltage transient. The measurement screenshot 402 shows output voltage and current waveforms along with input power with the input power waveform including the peak input power as described herein.

Diagram 400C in FIG. 4C shows a measurement screenshot 404 for the third example scenario, where the current ramp up rate is slowed while the voltage ramp up rate is maintained resulting in a smaller peak component 414 of the input power from the current transient. The measurement screenshot 404 shows output voltage and current waveforms along with input power with the input power waveform including the peak input power as described herein.

Diagram 400D in FIG. 4D shows a measurement screenshot 406 for the fourth example scenario, where the time offset being introduced between the voltage ramp up and the current ramp up. Thus, the voltage and current transients no longer overlap resulting in an even smaller overall peak input power 416. The measurement screenshot 406 shows output voltage and current waveforms along with input power with the input power waveform including the peak input power as described herein.

Diagram 400E in FIG. 4E shows a measurement screenshot 408 for the fifth example scenario, where the voltage ramp up profile is reversed and the voltage ramps down from a blanking voltage value instead of ramping up while the current ramp up profile is maintained. Thus, the voltage and current ramp profiles become complementary, achieving highest reduction in peak input power 418 among the displayed mitigation scenarios. The measurement screenshot 408 shows output voltage and current waveforms along with input power with the input power waveform including the peak input power as described herein.

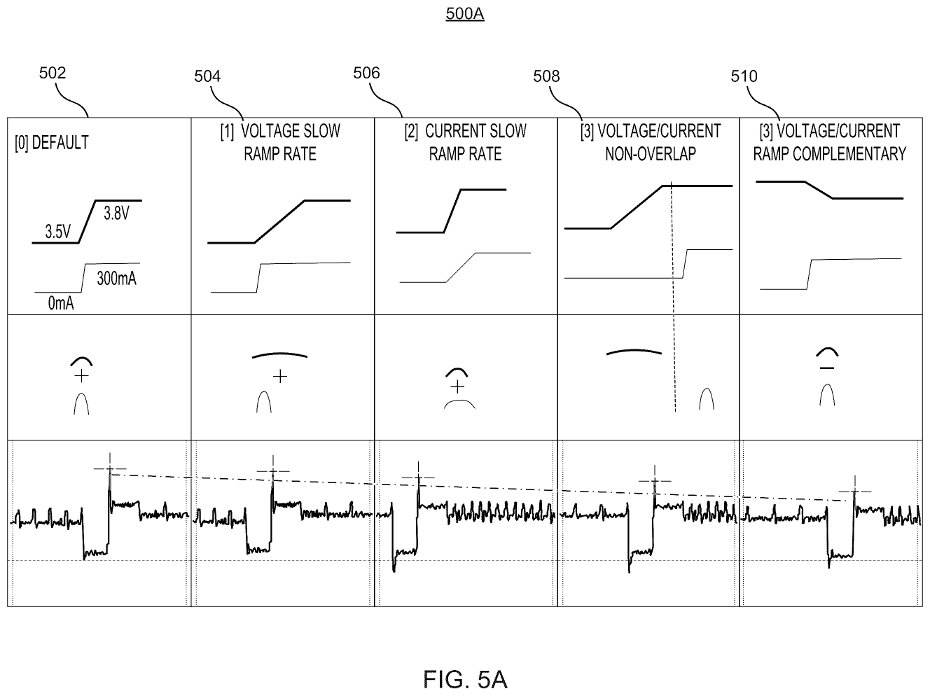

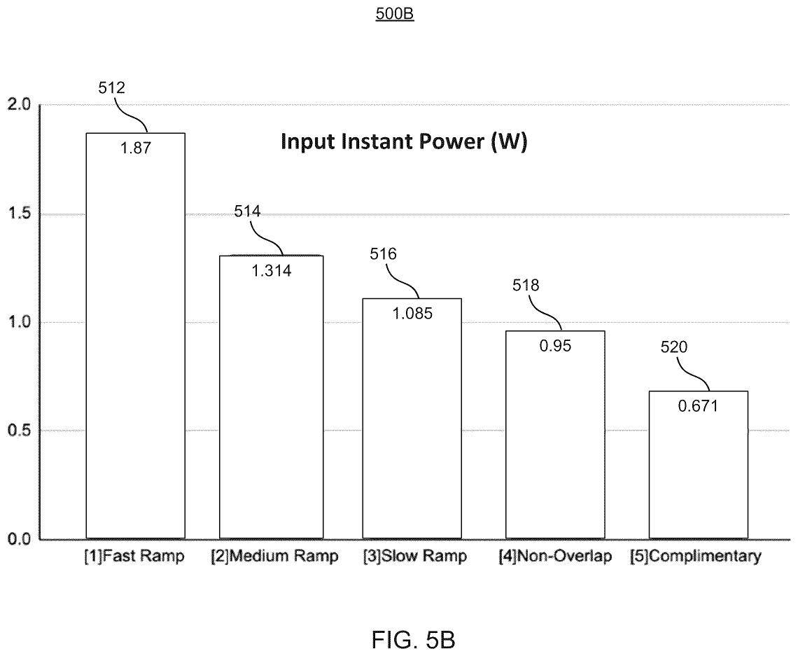

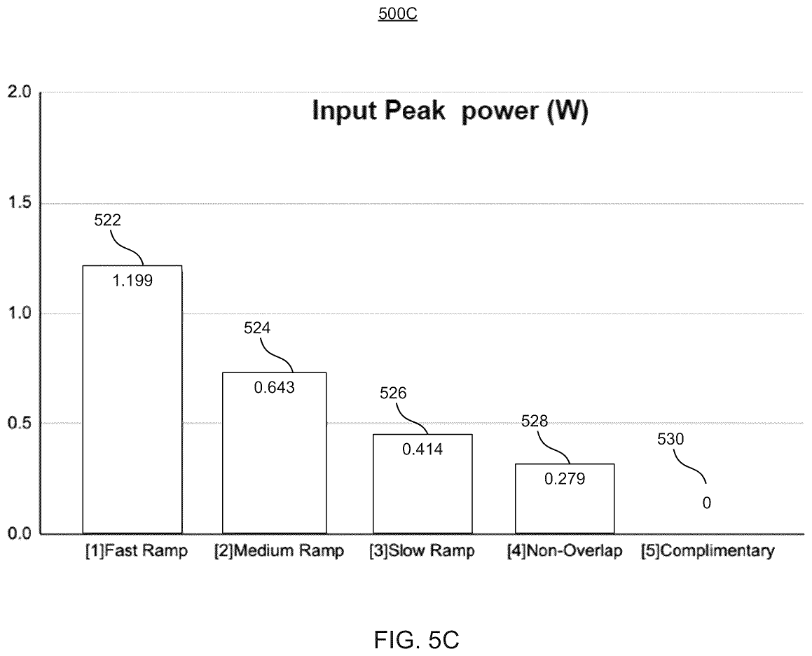

FIG. 5A illustrates representations of ramp-up voltage and current values and peak power from voltage and current transients, and measurements of peak power in various light emitting diode (LED) driver circuits, according to examples. Diagram 500A in FIG. 5A shows a comparison of unmitigated and four different mitigated ramp up scenarios of peak input power in a light emitting diode (LED) driver circuit.

A first example ramp up scenario 502 is the same as in FIG. 3, where the power peaks from transient voltage and current overlap and maximize the peak input power as shown in the measurement screenshot of the input power waveform at the bottom row. A second example scenario 504 shows the voltage ramp up rate being slowed while the current ramp up rate is maintained resulting in a smaller peak component of the input power from the voltage transient, thus the peak input power is smaller than the peak input power of the first scenario as shown in the measurement screenshot of the input power waveform at the bottom row. A third example scenario 506 shows the current ramp up rate being slowed while the voltage ramp up rate is maintained resulting in a smaller peak component of the input power from the current transient, thus the peak input power is smaller than the peak input power of the first and second scenarios as shown in the measurement screenshot of the input power waveform at the bottom row.

A fourth example scenario 508 in diagram 500A shows a time offset being introduced between the voltage ramp up and the current ramp up. Thus, the voltage and current transients no longer overlap resulting in an even smaller overall peak input power as shown in the measurement screenshot of the input power waveform at the bottom row. A fifth example scenario 510 shows the voltage ramp up profile being reversed, where the voltage ramps down from a blanking voltage value instead of ramping up while the current ramp up profile is maintained. Thus, the voltage and current ramp profiles become complementary achieving highest reduction in peak input power among the displayed mitigation scenarios as shown in the measurement screenshot of the input power waveform at the bottom row.

FIG. 5B illustrates a comparison of input instant powers from voltage and current transients in various light emitting diode (LED) driver circuits, according to examples. Diagram 500B shows input instant powers (W) for the five scenarios discussed in conjunction with FIG. 5A according to an example implementation.

As shown in diagram 500B, the highest input instant power is for the unmitigated light emitting diode (LED) driver circuit (512) with fast ramp-up. Voltage and current ramp up rate mitigation circuits (514, 516) provide smaller input instant powers. An even smaller input instant power may be achieved with the time offset mitigation circuit (518). The smallest input instant power may be achieved using the complementary voltage/current ramp up profile circuit (530).

FIG. 5C illustrates a comparison of input peak powers from voltage and current transients in various light emitting diode (LED) driver circuits, according to examples. Diagram 500C shows input peak powers (W) for the five scenarios discussed in conjunction with FIG. 5A according to an example implementation.

As shown in diagram 500C, the highest input peak power is for the unmitigated light emitting diode (LED) driver circuit (522) with fast ramp-up. Voltage and current ramp up rate mitigation circuits (524, 526) provide smaller input peak powers. An even smaller input peak power may be achieved with the time offset mitigation circuit (528). The smallest input peak power may be achieved using the complementary voltage/current ramp up profile circuit (520).

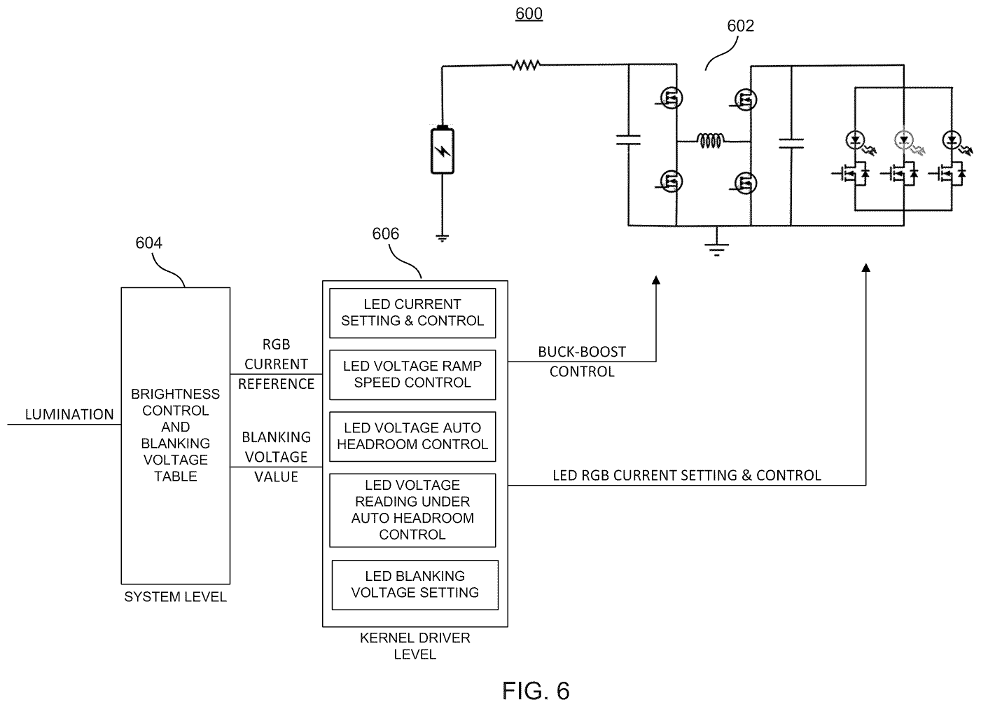

FIG. 6 illustrates a schematic diagram of a light emitting diode (LED) drive control system for a pixel of a display and mitigation of peak input power processes, according to examples. Diagram 600 includes an example light emitting diode (LED) driving circuit 602 for a pixel of a display device with DC power source. Diagram 600 also shows a liquid crystal on silicon (LCOS) application specific integrated circuit (ASIC) 604 providing a red-green-blue current reference and a light emitting diode (LED) enable signal for light emitting diode (LED) driver control processes 606. The light emitting diode (LED) driver control processes 606 may include light emitting diode (LED) current control (including current ramp up rate or time offset control), light emitting diode (LED) blanking voltage setting, light emitting diode (LED) voltage control (including voltage ramp up and ramp down rate control), and light emitting diode (LED) driver headroom control.

The light emitting diode (LED) driver control processes 606 may provide buck-boost control a buck-boost DC-to-DC converter portion of the light emitting diode (LED) driving circuit 602, thereby controlling the light emitting diode (LED) voltage. The light emitting diode (LED) driver control processes 606 may also control a current of the light emitting diodes (LEDs) (red, green, blue).

In some examples, the voltage ramp up rate decrease may be achieved by controlling the voltage ramp up rate through the light emitting diode (LED) driver silicon. The current ramp up rate decrease may be achieved by controlling the current ramp up rate through the light emitting diode (LED) driver silicon or liquid crystal on silicon (LCOS) digital process. The light emitting diode (LED) driver silicon may also be used to introduce a time offset to the current ramp up, while the light emitting diode (LED) driver silicon or liquid crystal on silicon (LCOS) digital process may be used to introduce time offset to the voltage ramp up. The light emitting diode (LED) driver silicon may further be used to set a different blanking voltage to match with light emitting diode (LED) current during the ramp up.

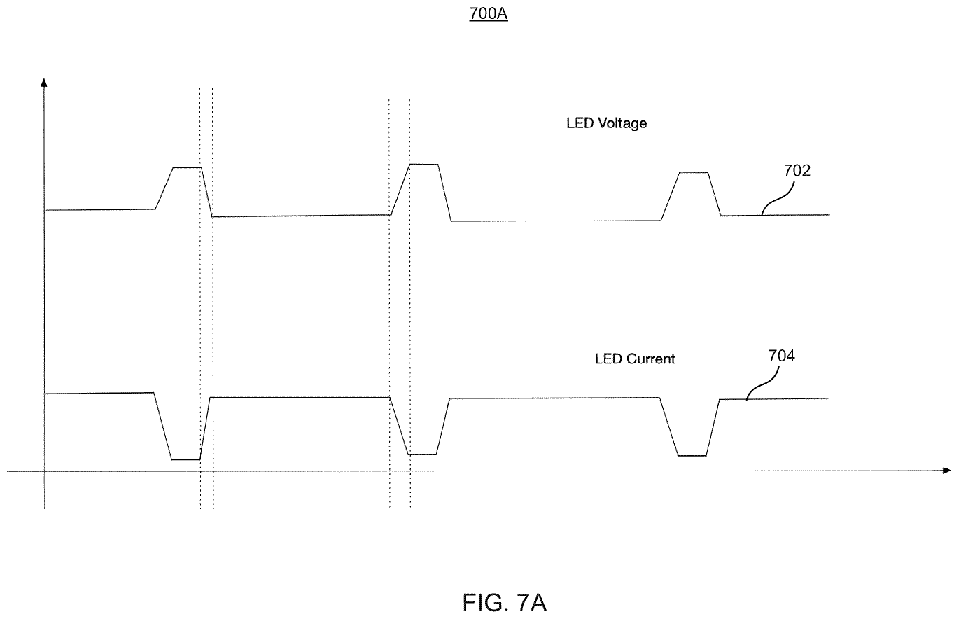

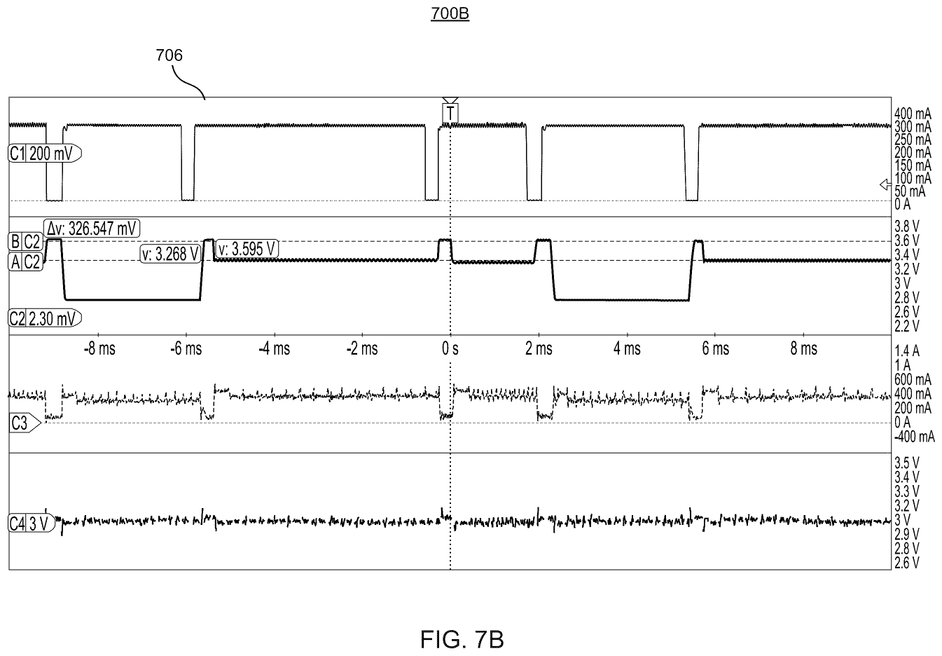

FIG. 7A illustrates light emitting diode (LED) voltage and current graphs for a complementary voltage-current ramping technique, according to examples. Diagram 700A shows light emitting diode (LED) voltage 702 and current 704 using complementary ramping mitigation for peak input power.

As shown in diagram 700A, a blanking voltage of the light emitting diodes (LEDs) may be set such that the ramping profiles of the light emitting diode (LED) voltage and current are substantially reversed (complementary). This may allow the peak input power components from the voltage and current transients to reduce each other instead of being additive. Thus, the highest peak input power reduction among the discussed mitigation approached may be achieved.

FIG. 7B illustrates light emitting diode (LED) voltage, current, and power measurement for a complementary voltage-current ramping technique, according to examples. Diagram 700B shows a measurement screenshot 706 of the output voltage and current waveforms of a light emitting diode (LED) driver circuit with complementary ramping profiles. As discussed herein, the complementary profiles may allow the peak input power components from the voltage and current transients to reduce each other instead of being additive as shown in the input power waveform of the measurement screenshot 706. Thus, the highest peak input power reduction among the discussed mitigation approached may be achieved.

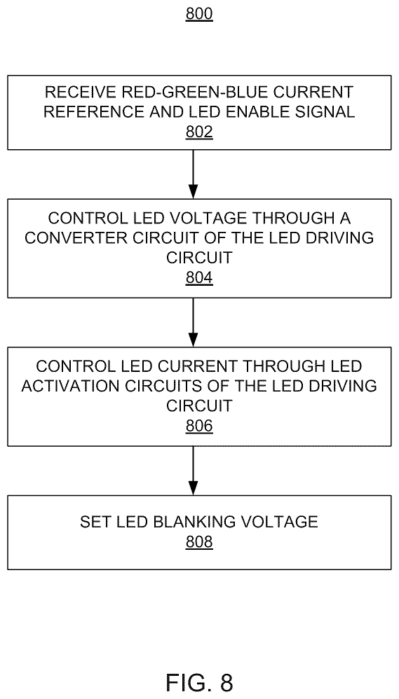

FIG. 8 illustrates a flow diagram for a method of mitigating peak input power for a light emitting diode (LED) driver circuit, according to examples. The method 800 is provided by way of example, as there may be a variety of ways to carry out the method described herein. Although the method 800 is primarily described as being performed by the components of FIG. 2A, the method 800 may be executed or otherwise performed by one or more processing components of another system or a combination of systems. Each block shown in FIG. 8 may further represent one or more processes, methods, or subroutines, and one or more of the blocks may include machine readable instructions stored on a non-transitory computer readable medium and executed by a processor or other type of processing circuit to perform one or more operations described herein.

At block 802, a liquid crystal on silicon (LCOS) application specific integrated circuit (ASIC) may provide a red-green-blue current reference and a light emitting diode (LED) enable signal to control operation of the light emitting diode (LED) driver circuit.

At block 804, the liquid crystal on silicon (LCOS) application specific integrated circuit (ASIC) may control light emitting diode voltages (thereby the ramp up or down profile of the voltages) through a converter circuit of the light emitting diode driver.

At block 806, the liquid crystal on silicon (LCOS) application specific integrated circuit (ASIC) may control light emitting diode currents (thereby the ramp up or down profile of the currents) through activation circuits of the light emitting diodes.

At block 808, the liquid crystal on silicon (LCOS) application specific integrated circuit (ASIC) may set a blanking voltage for the light emitting diodes (LEDs) for the complementary peak input power mitigation.

According to examples, a method of making a light emitting diode (LED) driving circuit with peak input power mitigation is described herein. A system of making the light emitting diode (LED) driving circuit is also described herein. A non-transitory computer-readable storage medium may have an executable stored thereon, which when executed instructs a processor to perform the methods described herein.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A drive control system for a light emitting diode (LED) display device, comprising:
an LED driver comprising a converter circuit and at least one activation circuit;
a liquid crystal on silicon (LCOS) application specific integrated circuit (ASIC) to provide an LED current reference and an LED enable signal;
an LED drive controller coupled to the LCOS ASIC, the LED drive controller to:
receive the LED current reference and the LED enable signal from the LCOS ASIC;
provide a first control signal to the converter circuit of the LED driver to control an LED voltage; and
provide a second control signal to the at least one activation circuit to control an LED current.

2. The drive control system of claim 1, wherein
the converter circuit is to provide voltage to red, green, and blue LEDs of a pixel of the LED display device; and
each of the red, green, and blue LEDs are coupled to an activation circuit.

3. The drive control system of claim 2, wherein the converter circuit comprises a buck-boost DC-to-DC converter.

4. The drive control system of claim 1, wherein the first control signal is to decrease an LED voltage ramp up rate.

5. The drive control system of claim 1, wherein the first control signal is to introduce a time offset to the LED voltage.

6. The drive control system of claim 1, wherein the first control signal is to set a blanking voltage value to render an LED voltage ramp up complementary to an LED current ramp up.

7. The drive control system of claim 1, wherein the second control signal is to decrease an LED current ramp up rate.

8. The drive control system of claim 1, wherein the second control signal is to introduce a time offset to the LED current.

9. The drive control system of claim 1, wherein the display device is an organic light emitting diode (OLED) display system, a microLED, liquid-crystal on silicon (LCOS), or a digital driving control-based display system.

10. A method, comprising:
receive a light emitting diode (LED) current reference and an LED enable signal from a liquid crystal on silicon (LCOS) application specific integrated circuit (ASIC);
modifying at least one of:
a ramp up profile of an LED voltage through a converter circuit of an LED driver; or
a ramp up profile of an LED current through at least one activation circuit of the LED driver; and
reducing a peak input power of the LED driver through the modification.

11. The method of claim 10, further comprising:
introducing a time offset to:
the LED voltage through the converter circuit of the LED driver; or
the LED current through the at least one activation circuit of the LED driver.

12. The method of claim 10, wherein modifying the ramp up profile of the LED voltage comprises:
decreasing an LED voltage ramp up rate while maintaining an LED current ramp up rate.

13. The method of claim 10, wherein modifying the ramp up profile of the LED current comprises:
decreasing an LED current ramp up rate while maintaining an LED voltage ramp up rate.

14. The method of claim 10, further comprising:
setting a blanking voltage value to render the ramp up profile of the LED voltage complementary to the ramp up profile of the LED current.

15. A light emitting diode (LED) display device, comprising:
a display panel comprising a plurality of pixels, wherein each pixel comprises a red LED, a green LED, and a blue LED; and
a drive control system comprising:
an LED driver comprising a converter circuit and at least one activation circuit;
a liquid crystal on silicon (LCOS) application specific integrated circuit (ASIC) to provide an LED current reference and an LED enable signal;
an LED drive controller coupled to the LCOS ASIC, the LED drive controller to:
receive the LED current reference and the LED enable signal from the LCOS ASIC;
provide a first control signal to the converter circuit of the LED driver to control an LED voltage; and
provide a second control signal to the at least one activation circuit to control an LED current.

16. The LED display device of claim 15, wherein the first control signal is to at least one of:
decrease an LED voltage ramp up rate;
introduce a time offset to the LED voltage; or
set a blanking voltage value to render an LED voltage ramp up complementary to an LED current ramp up.

17. The LED display device of claim 15, wherein the second control signal is to at least one of:
decrease an LED current ramp up rate; or
introduce a time offset to the LED current.

18. The LED display device of claim 15, wherein the converter circuit is to provide voltage to red, green, and blue LEDs of a pixel of the LED display device.

19. The LED display device of claim 18, wherein each of the red, green, and blue LEDs are coupled to an activation circuit.

20. The LED display device of claim 15, wherein the converter circuit comprises a buck-boost DC-to-DC converter.
